(19) United States
(12) Patent Application Publication
(10) Pub. No.: US 2017/0373454 A1
(43) Pub. Date: Dec. 28, 2017

(54) Laser Safety Device

(71) Applicants: Alexander Hay, Bellevue, WA (US); David Von Derau, Woodinville, WA (US)

(72) Inventors: Alexander Hay, Bellevue, WA (US); David Von Derau, Woodinville, WA (US)

(21) Appl. No.: 15/195,950

(22) Filed: Jun. 28, 2016

(51) Int. Cl. H01S 3/00; G02B 26/10; G03B 21/20; H01S 3/10

(52) U.S. Cl. CPC H01S 3/0071; H01S 3/10; G02B 26/10; G03B 21/2033

(57) ABSTRACT

A laser safety device may include a light source and scanner capable of projecting a beam of electromagnetic radiation, a device for measuring distance, a control subsystem that may be interconnected with the light source and the device for measuring distance. The control subsystem may change characteristics of the beam of light to prevent people or objects from being harmed by the electromagnetic radiation based on measured distances from the light source to the people or objects.

### FIELD

This invention relates generally to a laser safety device.

### BACKGROUND

Electromagnetic (EM) radiation has many forms, such as radio waves, microwaves, X-rays and gamma rays. EM radiation spans an enormous range of wavelengths and frequencies. This range is known as the electromagnetic spectrum. Lasers are devices that emit narrow beams of intense EM radiation. Laser is an acronym for “laser amplification by stimulated emission of radiation.” A laser beam has the special property that the light waves are coherent and usually of one wavelength or color.

In addition, a laser has a very small beam divergence over a distance, compared with a light source such as an ordinary filament lamp. This means that the same degree of hazard can be present both close to and far from the laser.

In general, laser light is not in itself harmful and behaves much like light from other sources in its interaction with the body. However, with sufficient power, laser in the visible to near-infrared range (400-1400 nm) can cause laser radiation to be concentrated into an extremely small spot on the retina which can destroy retinal photoreceptor cells. Exposure to laser radiation with wavelengths less than 400 nm and greater than 1400 nm are largely absorbed by the cornea and lens, leading to the development of cataracts or burn injuries. Infrared lasers are particularly hazardous since the body's protective “blink reflex” response is triggered only by visible light.

Accessible Emission Limit (AEL) is the maximum value of accessible laser radiation to which an individual should be exposed during the operation of a laser. The AEL values are in turn based on Maximum Permissible Exposure (MPE) levels. An MPE is a level of laser exposure or irradiance an individual could be exposed to without incurring an injury. MPE levels are specified for both the eye and skin as a function of the wavelength of the laser radiation and the duration of exposure. The Nominal Hazard Zone (NHZ) is a distance within which the irradiance of a beam is greater than the MPE. It is specific to a given wavelength and time of exposure. A different NHZ can also be defined for the beam's path to the eye—direct viewing, specular reflectance or diffuse reflectance. Nominal ocular hazard distance NOHD is used to determine how far away persons need to be from the laser source. NOHD is set at the distance where the laser irradiance falls below the MPE.

One way to control EM irradiance is through distance. Another way to control EM radiation is to increase beam divergence. The divergence, φ, of a laser beam, is the angle of the increase in the radius with distance from the optical aperture. Increased divergence allows power and visibility to be increased.

For a laser show, where there may be many different movement patterns, it may be nearly impossible to calculate the “worst case” location for viewing the show.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a laser safety device which may be comprised of a light source capable of projecting a beam of electromagnetic radiation, for example a laser, distance measuring system, a control subsystem, and a beam steering device that may be interconnected with the source. The distance measuring system may be configured to determine a distance to objects (including people) in a path of the beam. The distance measuring system may use many different methods for determining the distance to objects. The distance may be communicated to the control subsystem. The control subsystem may then adjust one or more attributes of the light source to stay within safety limits.

Many of the attendant features may be more readily appreciated as they become better understood by reference to the following detailed description considered in connection with the attached drawings.

### BRIEF DESCRIPTION OF THE DRAWINGS

FIG. 1 illustrates geometry of a laser beam.

FIG. 2 is a block diagram of a Laser Safety Device according to one embodiment.

FIG. 3 illustrates a Laser Safety Device in use, according to one embodiment.

FIG. 4 illustrates a Laser Safety Device in use, according to another embodiment.

Like reference numerals are used to designate like parts in the accompanying drawings.

### DETAILED DESCRIPTION

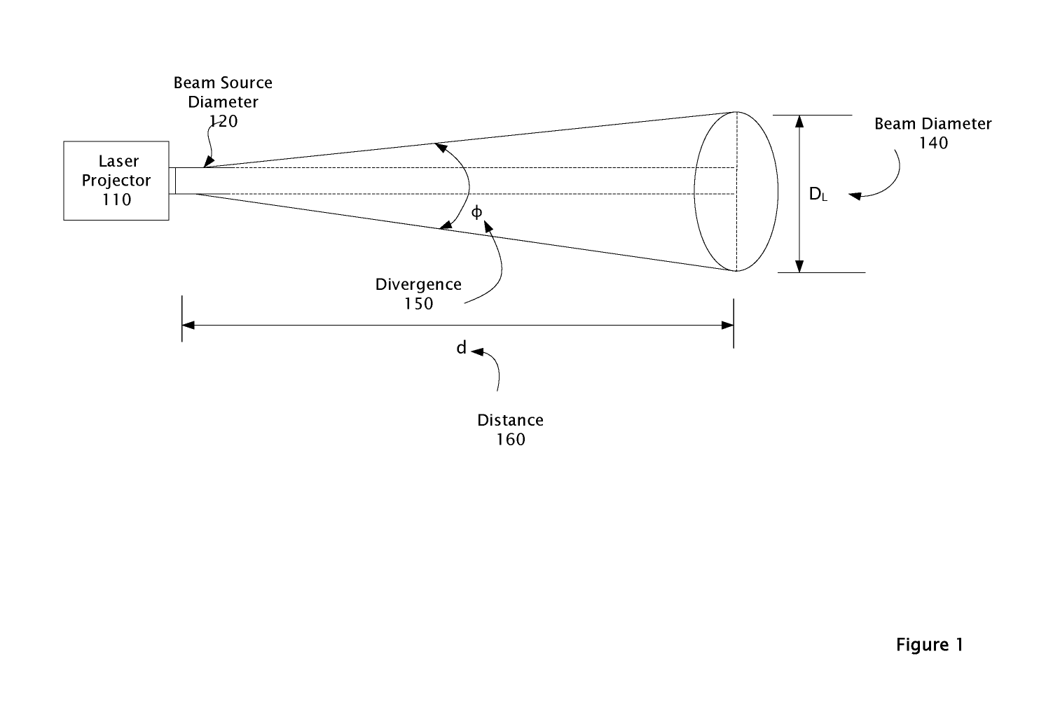

FIG. 1 illustrates geometry of a laser beam. Laser Projector 110 may include Light Source 220, which may generate a laser beam. Light Source 220 may generate a continuous, pulsed, or modulated laser beam. Beam Source Diameter 120 is the diameter of the narrowest portion of the laser beam. Divergence 150 is an angle the laser beam spreads over distance. Beam Diameter 140 (DL) is the diameter of the laser beam at Distance 160. Laser Projector 110 may also include Beam Steering Device 240, which may be one or more moveable mirrors, diffraction gratings, or other technology, which may allow moving or aiming of the laser beam.

Laser Projector 110 may also include Control Subsystem 210. Control Subsystem 210 may control attributes of Laser Source 110, including, for example, power output of Light Source 220, a frequency of pulses, Beam Source Diameter 120, or a velocity which Beam Steering Device 240 is effectively moving the laser beam.

Laser Projector 110 may also include Distance Measuring System (DMS) 230. DMS 230 may use radar, LIDAR, sonar, or other technology to determine a distance from Light Source 220 to an object.

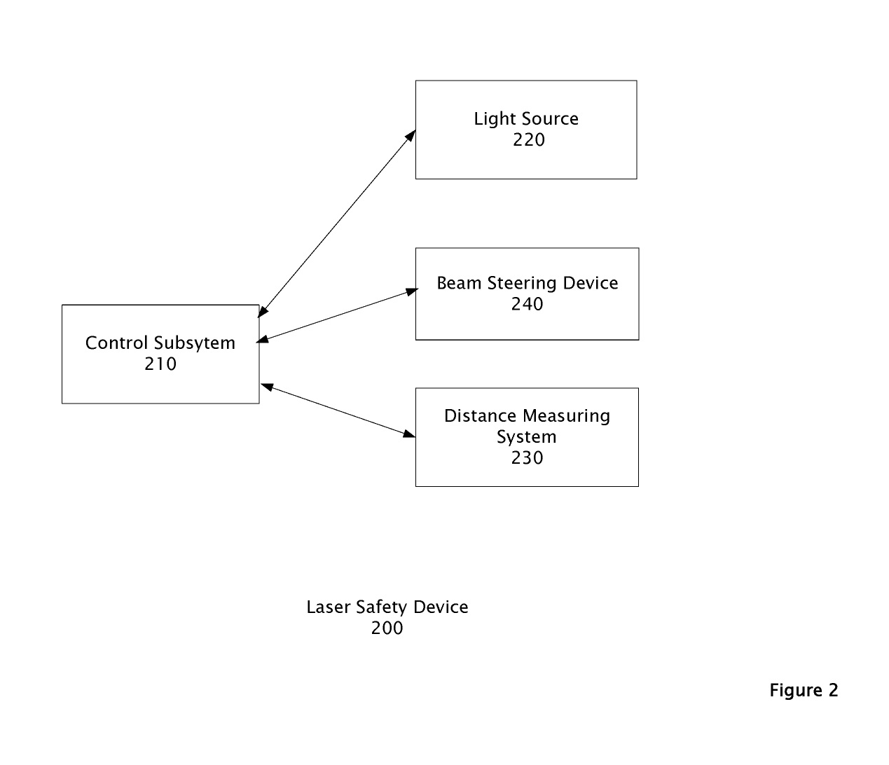

FIG. 2 illustrates Laser Safety Device 200 according to one embodiment. In this example, Laser Safety Device 200 may include Control Subsystem 210, Light Source 220, DMS 230 and Beam Steering Device 240.

Many types of light sources are contemplated, including laser, LED (Light Emitting Diode), OLED (Organic Light Emitting Diode), Xenon, incandescent, discharges, or plasma. Utilizing the correct optics, such as lenses, collimators, mirrors, and reflectors, almost any sufficiently bright illumination source may be focused into a defined beam. Examples in the instant disclosure use a laser source, but that is not intended as a limitation.

Beam Steering Device 240 may be any means of changing where Light Source 220 is effectively aimed, for example, mirrors, motors moving Light Source 220, rotating diffraction gratings, or lenses.

One embodiment of the instant disclosure may provide DMS 230 the ability to automatically measure distances to various locations. DMS 230 may have the ability to distinguish Audience 350 members from other objects or structures in real time. Using these values, Control Subsystem 210 may automatically monitor and make adjustments to various parameters in Light Source 220, for example optical power, Divergence 150, or beam velocity, to automatically adjust irradiance at the point of closest viewer access to be within limits of applicable MPE for example. Adjustments may account for average, single pulse, or multiple pulses. Adjustments may account for eye levels or exposed skin of any sitting or standing observer whenever possible along the laser's intended path accounting for possible changes in its path due to reflections, refractions, etc. for example.

In some embodiments, DMS 230 may calculate distance using active means such as electromagnetic (EM) radiation or sound (pressure) waves. The distance to objects may be communicated to Control Subsystem 210. Control Subsystem 210 may then adjust one or more parameters in Light Source 220 such as optical power, Divergence 150, Beam Source Diameter 120, beam velocity, pulse length, or pulse frequency, based on distance to the object and may further adjust these parameters based on the objects' properties such as whether the object is a person, an inanimate object, or whether, for example, the object may reflect or refract the light beam. Adjustment may allow for the Light Source 220 to be at a high intensity while remaining within safety regulations. In some embodiments, DMS 230 may continually scan and communicate to Control Subsystem 210 any changes in the landscape, for example, a member of Audience 350 suddenly standing up. The Control Subsystem 210 may then adjust Light Source 220 to enhance safety.

Control Subsystem 210 may be able to change many attributes of Light Source 220. One method may be to reduce the output power of Light Source 220. A reduction in output power of Light Source 220 may reduce the overall light that is produced by Light Source 220 and consequently, the output illumination. In another embodiment, Control Subsystem 210 may control, for example, Beam Source Diameter 120, diffraction of the beam, Divergence 150, diffusion, beam shutter, beam focus, beam velocity, pulse frequency, pulse length, or other attributes that may be adjusted.

Distance Measuring System 230 may be able to measure the distance to objects in the beam path. This may allow Control Subsystem 210 to adjust Light Source 220 beam attributes to enhance safety. In some cases, some methods may determine more information than just distance such as density of an object, velocity of an object, vector of an object, or other attributes.

In some instances, DMS 230 may continuously determine object distances through all possible beam paths. By determining object distance continuously in real-time, Light Source 220 may be adjusted to allow a high intensity in a safe manner. For instance, a laser may shine on Audience 350 at the brightest setting that is still within safety requirements.

In another embodiment, DMS 230 may determine distances to people or objects in advance of a laser show, and store distances in different directions, providing Control Subsystem 210 with distance measurements based on where the beam is pointing. In another embodiment, Control Subsystem may be programmed in advance with distances in various directions, and may adjust attributes appropriately.

In yet another embodiment, DMS 230 may determine a closest distance for any objects for a location at which a beam is aimed. Control Subsystem 210 may adjust Laser Projector 110 to enhance safety for the closest object at the location.

In yet another embodiment, Beam Steering Device 240 may be adjusting over a path where a beam is aimed. Distance Measuring System 230 may receive the path from Control Subsystem 210, and may determine a closest object across the path. Control Subsystem 210 may adjust Laser Projector 110 to an acceptable level for the closest object to enhance safety to all objects in the path.

One having skill in the art will recognize that many approaches may be used to provide distance measurements to enhance safety for laser use.

In other embodiments, the laser projector may have more than one Light Source 220. For example, if Light Source 220 is an RGB laser projector, there may be three laser sources: one for each primary color: red, green, and blue. In this configuration, multiple colors may be mixed to together in different output amplitudes to create a large gamut of the colors capable of being seen by the human eye. Each laser source may comprise a single laser emitter or multiple laser emitters. It may be preferable that these lasers are color-balanced, but they may have a maximum power output that is not uniform. In this embodiment, Control Subsystem 210 may take each laser's power into consideration when determining the proper attribute adjustments for each laser and the attribute adjustments for the projector. In some cases, Control Subsystem 210 may adjust beam velocity or a shutter module.

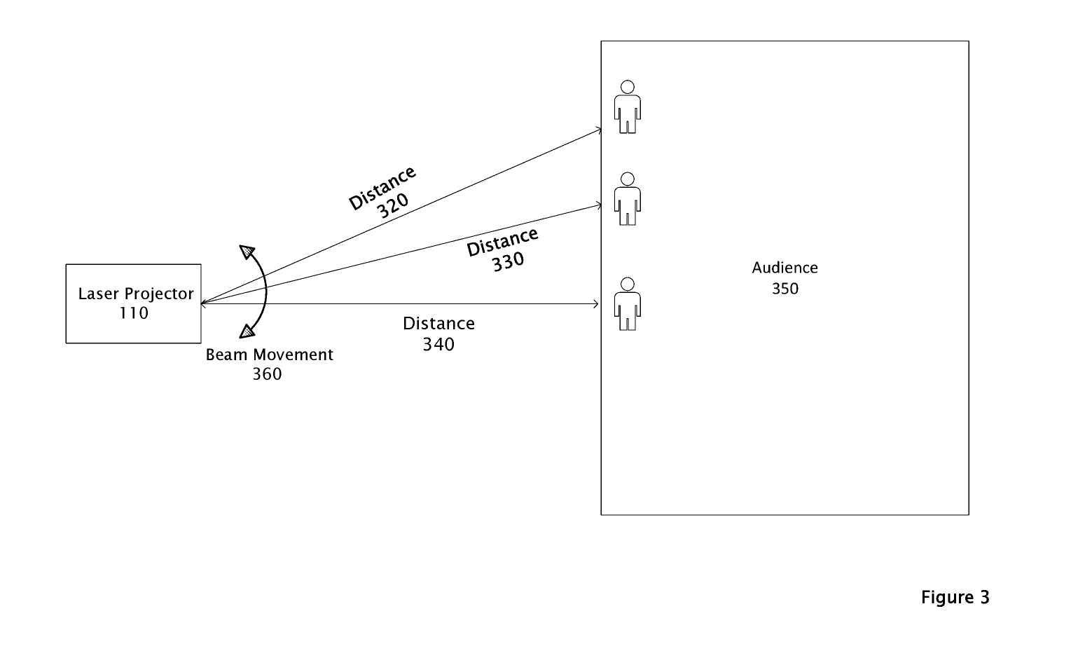

FIG. 3 illustrates a Laser Safety Device 200 in use, according to one embodiment. Laser Projector 110 may include Beam Steering Device 240 to move a beam through Beam Movement 360, changing where the beam is aimed. Beam Movement 360 may be any shape. Lenses, mirrors, shutters, absorbers, and other accessories may be added to Laser Projector 110 to obtain more power, pulses, modulation, or special beam shape. DME 230 may measure Distance 320, 330, 340 and provide Control Subsystem 210 the resulting measurements, which may allow Control Subsystem 210 to adjust attributes of Laser Projector 110 to enhance safety for members of Audience 350.

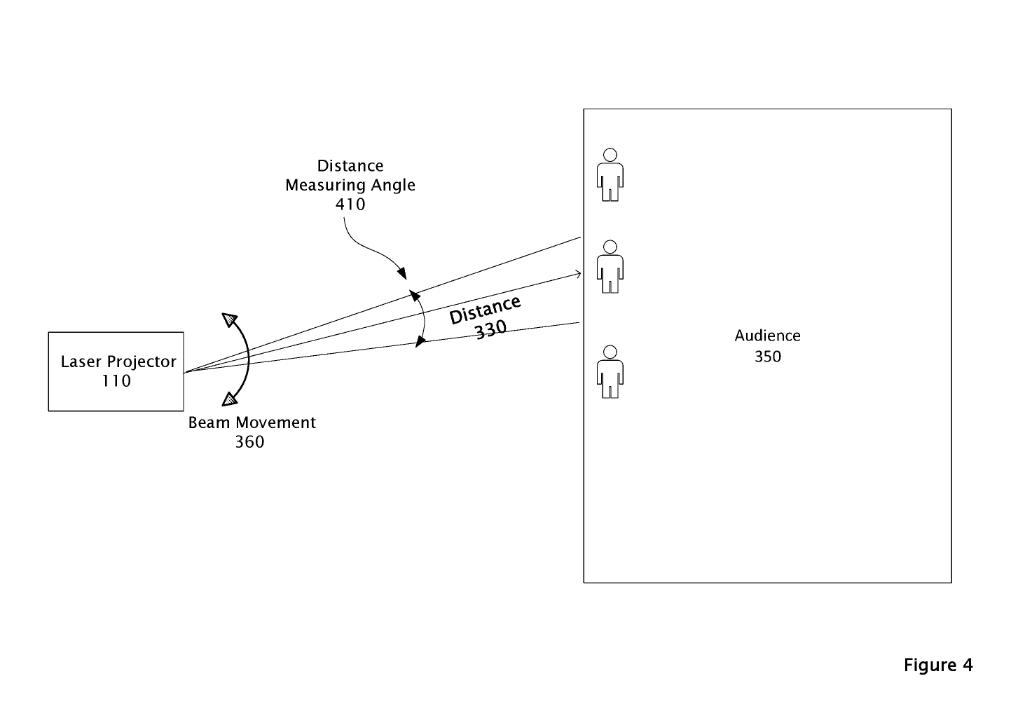

FIG. 4 illustrates a Laser Safety Device 200 in use, according to another embodiment. DMS 230 may measure a distance to the nearest object over Distance Measuring Angle 410, which may be a wider angle than Divergence 150. When Beam Steering Device 240 is moving a beam, distances to objects within the range of Distance Measuring Angle 410 may be measured before the beam hits them. This may allow time for Control Subsystem 210 to adjust power appropriately before an object is hit by the beam.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

What is claimed is:

1. A system comprising:
a light source;
a device for measuring distance; and
a control subsystem operably coupled to the light source and the device for measuring distance configured to adjusts parameters of the light source based on a distance to an object, as determined by the device for measuring distance.

2. The system of claim 1 wherein the device for measuring distance is integrated with the control subsystem.

3. The system of claim 1 wherein the device for measuring distance is separate from the control subsystem.

4. The system of claim 1 wherein the device for measuring distance uses electromagnetic or pressure waves.

5. The system of claim 1 wherein the control subsystem adjusts the irradiance of the light to be within safety limits.

6. The system of claim 1 wherein the light source is one or more lasers.

7. The system of claim 1 wherein the device for measuring distance is configured to determine a point to which the laser will project, determine a distance to the object, and send the point and distance to the control subsystem adjusts the attributes of the laser to reduce exposure to object.

8. The system of claim 1 wherein the device for measuring distance determines an area to which the laser will project, determines the distance to the object, whereby, the control subsystem adjusts the attributes of the laser to reduce exposure to object.

9. The system of claim 1 The apparatus of claim 1 further comprising a scanner.

10. The system of claim 1 wherein the control subsystem adjusts the irradiance of the light to be within safety limits.

11. The system of claim 10 wherein the control subsystem reduces irradiance to within safety limits by increasing divergence.

12. The system of claim 10 wherein the control subsystem reduces the irradiance to within safety limits by decreasing laser power output.

13. A system comprising:
a laser for emitting light beams;
a means for measuring distance, the means for measuring distance configured to measure distance to objects within a path of the light beams; and
a control subsystem interconnected to the laser and to the means for measuring distance, the control subsystem configured to receive data from the means for measuring distance and adjust an attribute of the laser to provide a safe exposure to objects in the projection path based upon at least the distance to each object.

14. The system of claim 13 wherein the control subsystem further adjusts an attribute of the laser based on an item from the group comprising angular beam velocity, beam diameter, beam divergence, and a planned beam direction.

15. The system of claim 13 wherein the means for measuring distance utilizes electromagnetic or pressure waves to measure distance.

16. A method of reducing light exposure comprising:
providing a directional illumination device;
providing a distance measuring system;
determining an illumination path prior to illumination of the illumination path;
determining a distance to an object in the illumination path; and
varying an attribute of the illumination device based on the distance to the object.

17. The method of claim 16 where the attribute of the illumination device is selected from the group comprising light output, pulse length, pulse frequency, modulation, and divergence.
